(19) United States
(12) Patent Application Publication
(10) Pub. No.: US 2015/0232631 A1
(43) Pub. Date: Aug. 20, 2015

(54) RIGID POLYURETHANE FOAMS WITH REDUCED SHRINKAGE

(71) Applicant: BASF SE, Ludwigshafen (DE)

(72) Inventors: Marco Balbo Block, Osnabrueck (DE); Yayun Wang, Shanghai (CN); Cheul Hyeon Hwang, Daejeon (KR); Bangwei Xi, Lemfoerde (DE)

(73) Assignee: BASF SE, Ludwigshafen (DE)

(21) Appl. No.: 14/426,535

(22) PCT Filed: Sep. 6, 2013
(86) PCT No.: PCT/EP2013/068421

§ 371 Date: Mar. 6, 2015

(30) Foreign Application Priority Data
Sep. 7, 2012 (CN) PCT/CN2012/081133

(51) Int. Cl. C08J 9/14; F17C 13/00; C08J 9/00

(52) U.S. Cl. CPC C08J 9/144; C08J 9/0066; F17C 13/00; C08J 2375/06; C08J 2203/162; C08J 2205/10; F17C 2203/0333

(57) ABSTRACT

A rigid polyurethane foam obtainable by mixing a) isocyanates, b) compounds having groups which are reactive toward isocyanates, c) a blowing agent, d) a catalyst, e) one or more foam stabilizer, and optionally, f) further additives to form a reaction mixture, applying the reaction mixture to a reinforcing material and curing the reaction mixture, wherein the isocyanates (a) have a viscosity of not more than 600 mPas at 25° C. and the compounds (b) having groups which are reactive toward isocyanates comprise (b1) 45-70 wt-% (based on the total weight of (b) of an aromatic polyester polyol having a functionality of 2.5 or less and a hydroxyl number of more than 220 mg KOH/g (b2) 20-40 wt.-% (based on the total weight of (b) of a polyether polyol having a functionality of 4 or more and a hydroxyl number of more than 400 mg KOH/g, and (b3) more than 15 wt.-% (based on the total weight of (b) one or more low molecularweight chain extender and/or one or more crosslinker and/or one or more o-toluene diamine initiated polyether polyol (“TDA polyol”), and wherein the blowing agent comprises 1-chloro-3,3,3-trifluoropropene shows low thermal conductivity values and little shrinkage and its liquid reaction mixture fast wetting and penetration into a stack of several glass fiber mat layers.

The invention relates to a rigid polyurethane foam, to a process for producing it, and to its use as an insulating material, specifically for liquefied gas transport tanks such as liquefied gas tanker tanks.

Apart from petroleum, natural gas is one of the most important energy sources of our time. However, to bring the gas from the sources to the customers, it usually has to be transported over great distances. This is achieved, for example, via pipelines. However, the transport of natural gas via pipelines to outlying areas or over very large distances is very expensive. In addition, the political situation in some countries may make it impossible to establish pipelines. In such cases, transport by sea in natural gas tankers (known as liquefied natural gas (LNG) carriers) is frequently chosen as an alternative. For this purpose, the natural gas is liquefied on land and placed in enormous tanks on board ships. Since natural gas can only be liquefied at very low temperatures of about −160° C. and also has to be stored and transported at these temperatures at atmospheric pressure, it is necessary to insulate the tanks, especially on board ships, as well as possible in order to keep the loss of liquefied gas by evaporation low.

As insulation material, use is primarily made of rigid polyurethane foams because of their excellent insulating properties compared to other insulation materials such as polystyrene foam or mineral wool.

The overall construction of insulation in liquefied natural gas carriers is extremely complex. Thus, the insulation of the tanks not only has to prevent evaporation of natural gas but also has to give the tanks a certain degree of stability. Thus, apart from rigid polyurethane foam, use is made of, for example, plywood, fiberglass and stainless steel layers to stabilize the tanks.

The actual tanks usually comprise a very thin barrier layer of stainless steel, so that the insulation structure provides a major part of the required stability. The rigid polyurethane foam which is mostly used thus has quite a high density. Furthermore, it preferably comprises reinforcing materials, usually glass fiber mats (CSMs—continuous strand mats), which provide the necessary mechanical properties. In order to be able to ensure optimal stability, uniform distribution of these continuous strand mats over the total thickness of the foam is an important parameter.

Such insulation structures are described, for example, in Korean patent KR 2000-010021 and KR 2000-010022, Japanese patent applications JP 2003-240198 and JP 2001-150558, US patent applications US 2005/0115248, US 2007/0015842, U.S. Pat. Nos. 3,319,431 and 3,341,050, EP-A 1 698 649, WO 2008/083996, and WO 2010/066635.

In the case of rigid foams which are subjected to large temperature differences and temperature changes, shear forces occur within the foam body. Since the polyurethane foam is a thermal insulator, a temperature gradient arises in the foam body, resulting in a shrinkage/expansion gradient which in turn leads to shear forces within the foam body. Shear strength is also an important property for rigid foams which are subjected to transverse stresses, as occur, for example, on ships carrying a liquid load. For this reason, rigid polyurethane foams which are used for the insulation of tanks for liquefied natural gas have to have not only good mechanical properties such as compressive strength and compressive modulus of elasticity (Young's modulus) but also a particularly high shear strength.

As blowing agents, use is usually made of halogenated blowing agents such as chlorofluorocarbons and fluorinated hydrocarbons, since foams having a particularly low thermal conductivity are obtained in this way. However, chlorofluorocarbons are responsible for destruction of the ozone layer and both chlorofluorocarbons and fluorinated hydrocarbons are gases which contribute to global warming. For these reasons, alternatives have to be sought.

Halogen-free physical blowing agents like hydrocarbons can be used, but they are highly flamable and can cause a false alarm of the natural gas leakage detectors. Chemical blowing agents like water or formic acid can also be used, but they lead to foams with high thermal conductivity. Physical blowing agents like hydrofluoroolefines, also called next generation blowing agents or 4^{th} generation blowing agents, have low thermal conductivity, low or no ozone depleting potential and low global warming potential. But when used in rigid foams with low crosslinking density, as described in this application, they lead to a strong foam shrinkage.

It is an object of the invention to provide a rigid polyurethane foam which is suitable for the insulation of liquefied natural gas tanks on board of ships, in which the conventional chlorofluorocarbons or fluorinated hydrocarbons used as blowing agents have been entirely or partly replaced by alternative blowing agents and which has very good mechanical properties such as compressive strength, compressive modulus of elasticity and shear strength, as well as a low thermal conductivity and low shrinkage at low cross linking densities. In addition, the reaction mixture leading to the inventive rigid foam should have a fast wetting of glass fibers and fast penetration into glass fiber mat layers.

The object of the invention is achieved by a rigid polyurethane foam obtainable by mixing

a) isocyanates,

b) compounds having groups which are reactive toward isocyanates,

c) a blowing agent,

d) a catalyst,

e) one or more foam stabilizers, and optionally

f) further additives
to form a reaction mixture, applying the reaction mixture to a reinforcing material and curing the reaction mixture,

wherein the isocyanates (a) have a viscosity of not more than 600 mPas at 25° C. and the compounds (b) having groups which are reactive toward isocyanates comprise

(b1) 45-70 wt-%, based on the total weight of (b), of an aromatic polyester polyol having a functionality of 2.5 or less and a hydroxyl number of more than 220 mg KOH/g (Polyol 1)

(b2) 20-40 wt.-%, based on the total weight of (b), of a polyether polyol having a functionality of 4 or more and a hydroxyl number of more than 400 mg KOH/g (Polyol 2), and

(b3) more than 15 wt.-%, based on the total weight of (b), one or more low molecular weight chain extender and/or one or more crosslinker and/or one or more o-toluene diamine initiated polyether polyol (“TDA polyol”) (collectively Polyol 3),

and wherein the blowing agent comprises 1-chloro-3,3,3-trifluoropropene (refered to as hydrofluorocarbon olefin, “HFCO”).

The polyols (b1) and (b2) can be single polyols or mixtures of polyols in a way, that the mixture of polyols complies with the definitions of (b1) and (b2), respectively.

As isocyanates (a), it is possible to use all usual aliphatic, cycloaliphatic and preferably aromatic diisocyanates and/or polyisocyanates which have a viscosity of less than 600 mPas, preferably less than 500 mPas and particularly preferably less than 250 mPas, measured at 25° C. Particular preference is given to tolylene diisocyanate (TDI) and diphenylmethane diisocyanate (MDI) and in particular mixtures of diphenylmethane diisocyanate and polymeric diphenylmethane diisocyanate (PMDI) as isocyanates. These particularly preferred isocyanates are optionally entirely or partially modified with uretdione, carbamate, isocyanurate, carbodiimide, allophanate and/or preferably, urethane groups.

Furthermore, prepolymers and mixtures of the above-described isocyanates and prepolymers can be used as isocyanate component. These prepolymers are prepared from the above-described isocyanates and the polyethers, polyesters or both described below and have an NCO content of from 14 to 35% by weight, preferably from 22 to 32% by weight.

As compounds (b) having groups which are reactive toward isocyanates, it is possible to use all compounds which have at least two groups which are reactive toward isocyanates, e.g. OH-, SH-, NH- and CH-acidic groups. It is usual to use polyetherols and/or polyesterols having from 2 to 8 hydrogen atoms which are reactive toward isocyanate. The OH number of these compounds is usually in the range from 50 to 850 mg KOH/g, preferably in the range from 80 to 600 mg KOH/g. The use of polyols with OH-values lower than 50 mg KOH/g leads to strong shrinkage and/or poor mechanical properties, especially in low cross linked foams as described herein.

The polyetherols are obtained by known methods, for example by anionic polymerization of alkylene oxides with addition of at least one starter molecule which comprises from 2 to 8, preferably from 2 to 6, reactive hydrogen atoms in bound form in the presence of catalysts. As catalysts, it is possible to use alkali metal hydroxides such as sodium or potassium hydroxide or alkali metal alkoxides such as sodium methoxide, sodium or potassium ethoxide or potassium isopropoxide or, in the case of cationic polymerization, Lewis acids such as antimony pentachloride, boron trifluoride etherate or bleaching earth as catalysts. Furthermore, double metal cyanide compounds, known as DMC catalysts, can also be used as catalysts.

As alkylene oxides, preference is given to using one or more compounds having from 2 to 4 carbon atoms in the alkylene radical, e.g. tetrahydrofuran, 1,3-propylene oxide, 1,2- or 2,3-butylene oxide, in each case either alone or in the form of mixtures, and preferably ethylene oxide and/or 1,2-propylene oxide.

Possible starter molecules are, for example, ethylene glycol, diethylene glycol, glycerol, trimethylolpropane, pentaerythritol, sugar derivatives such as sucrose, hexitol derivatives such as sorbitol, methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine and other dihydric or polyhydric alcohols or monofunctional or polyfunctional amines.

Polyether polyols can also include natural oil-based polyols like castor oil or also alkoxylated modified natural oils or fatty acids.

The polyester alcohols used are usually prepared by condensation of polyfunctional alcohols having from 2 to 12 carbon atoms, e.g. ethylene glycol, diethylene glycol, butanediol, trimethylolpropane, glycerol or pentaerythritol, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, the isomers of naphthalenedicarboxylic acids or the anhydrides of the acids mentioned. This includes also other sources of dicarboxylic acids like dimethylterephthalate (DMT), polyethyleneglycol-terephthalate (PET) and the like.

As further starting materials in the preparation of the polyesters, it is also possible to make concomitant use of hydrophobic materials. The hydrophobic materials are water-insoluble materials comprising a nonpolar organic radical and also having at least one reactive group selected from among hydroxyl, carboxylic acid, carboxylic ester and mixtures thereof. The equivalent weight of the hydrophobic materials is preferably in the range from 130 to 1000 g/mol. It is possible to use, for example, fatty acids such as stearic acid, oleic acid, palmitic acid, lauric acid or linoleic acid and also fats and oils such as castor oil, maize oil, sunflower oil, soybean oil, coconut oil, olive oil or tall oil. If polyesters comprise hydrophobic materials, the proportion of the hydrophobic materials, based on the total monomer content of the polyester alcohol, is preferably from 1 to 30 mol %, particularly preferably from 4 to 15 mol %.

The polyesterols used preferably have a functionality of from 1.5 to 2.5, particularly preferably 1.8-2.4 and in particular from 1.9 to 2.2.

The compound (b) having groups which are reactive toward isocyanates further comprises chain extenders and/or crosslinkers. As chain extenders and/or crosslinkers, use is made of, in particular, bifunctional or trifunctional amines and alcohols, in particular diols, triols or both, in each case having molecular weights of less than 350, preferably from 60 to 300 and in particular from 60 to 250. Here, bifunctional compounds are referred to as chain extenders and trifunctional or higher-functional compounds are referred to as crosslinkers. It is possible to use, for example, aliphatic, cycloaliphatic and/or aromatic diols having from 2 to 14, preferably from 2 to 10, carbon atoms, e.g. ethylene glycol, 1,2-, 1,3-propanediol, 1,2-, 1,3-pentanediol, 1,10-decanediol, 1,2-, 1,3-, 1,4-dihydroxycyclohexane, diethylene glycol and triethylene glycol, dipropylene glycol and tripropylene glycol, 1,4-butanediol, 1,6-hexanediol and bis(2-hydroxyethyl)hydroquinone, triols such as 1,2,4-, 1,3,5-trihydroxycyclohexane, glycerol and trimethylolpropane and low molecular weight hydroxyl-comprising polyalkylene oxides based on ethylene oxide and/or 1,2-propylene oxide and the abovementioned diols and/or triols as starter molecules.

It is important for the invention that the compounds (b) having groups which are reactive toward isocyanates comprise an aromatic polyester polyol having a functionality of 2.5 or less and a hydroxyl number of more than 220 mg KOH/g (Polyol 1) (b1), a polyether polyol having a functionality of 4 or more and a hydroxyl number of more than 400 mg KOH/g (Polyol 2) (b2), and one or more low molecular weight chain extender and/or one or more crosslinker and/or one or more o-toluene diamid initiated polyether polyol (“TDA polyol”) (collectively Polyol 3) (b3).

Preferred are rigid polyurethane foams according to the invention wherein all polyols have a viscosity below 13000 mPas (25° C.), preferably Polyol 1<5000 mPas, more preferably the viscosity of the mixture of Polyols 1 to 3 is below 5000 mPas.

Further preferred are rigid polyurethane foams according to the invention wherein the molar average OH-functionality of a polyol mixture of Polyols 1 to 3 is between 2.3 and 3.3 and/or the molar average total functionality of OH and NCO of the polyol mixture and the isocyanate component is between 2.5 and 3.0.

Further preferred are rigid polyurethane foams according to the invention wherein the aromatic content of a polyol mixture of Polyols 1 to 3 is>13% (based on wt.-% of benzene units in the polyols), which equals to>50% aromatic based polyols.

The chain extender has on average at least 30%, preferably at least 40%, particularly preferably at least 50% and in particular at least 60%, secondary OH groups (based on the total of OH groups). The chain extender can be an individual compound or a mixture. The chain extender preferably comprises dipropylene glycol, tripropylene glycol and/or 2,3-butanediol either alone or optionally in mixtures with one another or with further chain extenders. Thus, in a particularly preferred embodiment, dipropylene glycol is used together with a second chain extender, for example 2,3-butanediol, mono-propylene glycol or diethylene glycol, as chain extender.

In a further embodiment, the compounds (b) having groups which are reactive toward isocyanates comprise a crosslinker. As crosslinkers, preference is given to using 1,2,4-, 1,3,5-trihydroxycyclohexane, glycerol and/or trimethylolpropane. Preference is given to using glycerol as crosslinker.

The proportion of the component (b1) is preferably from 45. to 70% by weight, particularly preferably from 0.46 to 65.% by weight and in particular from 0.47 to 60% by weight, based on the total weight of the component (b).

The proportion of the component (b2) is preferably from 20 to 40% by weight, particularly preferably from 27 to 38.% by weight, based on the total weight of the component (b).

The proportion of the component (b3) is preferably from 15 to 25% by weight, particularly preferably from 15 to 20% by weight, based on the total weight of the component (b).

The proportion of the polyetherols (b1), (b2) and (b3) in the compound (b) having groups which are reactive toward isocyanates is preferably at least 95% by weight, particularly preferably at least 98% by weight and in particular 100% by weight, based on the total weight of the compound (b) having groups which are reactive toward isocyanates.

The total functionality of the component (b) is preferably between 2.3 and 3.3, particularly preferably between than 2.5 and 2.8 The average OH number of the component (b) is preferably greater than 250 mg KOH/g, particularly preferably in the range from 250 to 500 mg KOH/g and in particular in the range from 300 to 450 mg KOH/g.

If isocyanate prepolymers are used as isocyanates (a) the content of compounds (b) having groups which are reactive toward isocyanates is calculated with inclusion of the compounds (b) having groups which are reactive toward isocyanates which are used for preparing the isocyanate prepolymers.

As blowing agent (c) 1-chloro-3,3,3-trifluoropropene (HFCO) is used. The compound can be used in the (Z) or (E) configuration or as a (Z)/(E) mixture.

HFCO is commercially available under the trademark Solstice® from Honeywell International Inc. or as AFA-L1 from Arkema SA.

Additional physical or chemical co-blowing agents can be used. Preferably, HFCO is used in amounts of 90 mol-% of total amount of blowing agent c), more preferably 95 mol-%. Particularly preferable the blowing agent c) consists of HFCO.

It is well known that polyols and other additives can contain certain amounts of residual water, for example 0.2 w % of the total polyol mass. This can hardly be prevented or removed. According to the invention this potential residual amount of water is not counted as blowing agent c).

The blowing agent (c) is used in such an amount that the density of the rigid polyurethane foam formed by reaction of the components (a) to (f) is, without taking into account the reinforcing material, preferably in the range 75-200 g/l, more preferably 80-150 g/l, most preferably 80-120 g/l.

As catalysts (d), it is possible to use all compounds which accelerate the isocyanate-polyol reaction. Such compounds are known and are described, for example, in “Kunststoffhandbuch, volume 7, Polyurethane”, Carl Hanser Verlag, 3rd edition 1993, chapter 3.4.1. These comprise amine-based catalysts and catalysts based on organic metal compounds.

As catalysts based on organic metal compounds, it is possible to use, for example, organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates e.g. bismuth(III) neodecanoate, bismuth 2-ethylhexanoate and bismuth octanoate, or alkali metal salts of carboxylic acids, e.g. potassium acetate or potassium formate.

Preference is given to using a mixture comprising at least one tertiary amine as catalyst (d). These tertiary amines are usually compounds which can also bear groups which are reactive toward isocyanate, e.g. OH, NH or NH₂ groups. Some of the most frequently used catalysts are bis(2-dimethylaminoethyl)ether, N,N,N,N,N-pentamethyldiethylenetriamine, N,N,N-triethylaminoethoxyethanol, dimethylcyclohexylamine, dimethylbenzylamine, triethylamine, tri-ethylenediamine, pentamethyldipropylenetriamine, dimethylethanolamine, N-methylimidazole, N-ethylimidazole, tetramethylhexamethylenediamine, tris(dimethylaminopropyl)hexahydrotriazine, dimethylaminopropylamine, N-ethylmorpholine, diazabicycloundecene and diazabicyclononene.

The term foam stabilizers e) refers to materials which promote formation of a regular cell structure during foam formation. Examples which may be mentioned are: silicone-comprising foam stabilizers such as siloxane-oxyalkylene copolymers and other organopolysiloxanes. Alkoxylation products of fatty alcohols, oxo alcohols, fatty amines, alkylphenols, dialkylphenols, alkylcresols, alkylresorcinol, naphthol, alkylnaphthol, naphthylamine, aniline, alkylaniline, toluidine, bisphenol A, alkylated bisphenol A, polyvinyl alcohol and also further alkoxylation products of condensation products of formaldehyde and alkylphenols, formaldehyde and dialkylphenols, formaldehyde and alkylcresols, formaldehyde and alkylresorcinol, formaldehyde and aniline, formaldehyde and toluidine, formaldehyde and naphthol, formaldehyde and alkylnaphthol and also formaldehyde and bisphenol A. Mixtures of two or more of these foam stabilizers can also be used.

Foam stabilizers are preferably used in an amount of from 0.5 to 4% by weight, particularly preferably from 1 to 3% by weight, based on the total weight of the components (b) to (f). As further additives (f), it is possible to use flame retardants, plasticizers, further fillers and other additives such as antioxidants. Other additives may be used which specifically modify the viscosity of the polyol component b) to f) or which improve the compatibility among the components b) to f). Another class of possible additives are perfluorinated compounds like perfluorinated alkanes, alkenes, morpholines, furanes, or alkylamines. These additives are generally used to reduce the cell sizes of the foams.

As flame retardants, the flame retardants known from the prior art can generally be used. Suitable flame retardants are, for example, brominated ethers (Ixol B 251), brominated alcohols such as dibromoneopentyl alcohol, tribromoneopentyl alcohol and PHT-4-diol, and also chlorinated phosphates such as tris(2-chloroethyl)phosphate, tris(2-chloroisopropyl)phosphate (TCPP), tris(1,3-dichloroisopropyl)phosphate, tris(2,3-dibromopropyl)phosphate and tetrakis(2-chloroethyl)ethylenediphosphate, or mixtures thereof.

Apart from the abovementioned halogen-substituted phosphates, it is also possible to use inorganic flame retardants such as red phosphorus, preparations comprising red phosphorus, expandable graphite, aluminum oxide hydrate, antimony trioxide, arsenic oxide, ammonium polyphosphate and calcium sulfate or cyanuric acid derivatives such as melamine or mixtures of at least two flame retardants such as ammonium polyphosphates and melamine.

As further liquid halogen-free flame retardants, it is possible to use diethyl ethanephosphonate (DEEP), triethyl phosphate (TEP), dimethyl propylphosphonate (DMPP), diphenyl cresyl phosphate (DPC) and others.

For the purposes of the present invention, the flame retardants are preferably used in an amount of from 0 to 25% based on the total weight of the components (b) to (f).

As plasticizers, mention may be made by way of example of esters of polybasic, preferably dibasic, carboxylic acids with monohydric alcohols. The acid component of such esters can, for example, be derived from succinic acid, isophthalic acid, terephthalic acid, trimellitic acid, citric acid, phthalic anhydride, tetrahydrophthalic and/or hexahydrophthalic anhydride, endomethylenetetrahydrophthalic anhydride, glutaric anhydride, maleic anhydride, fumaric acid and/or dimeric and/or trimeric fatty acids such as oleic acid, optionally in admixture with monomeric fatty acids. The alcohol component of such esters can, for example, be derived from branched and/or unbranched aliphatic alcohols having from 1 to 20 carbon atoms, e.g. methanol, ethanol, propanol, isopropanol, n-butanol, sec-butanol, tert-butanol, the various isomers of pentyl alcohol, of hexyl alcohol, of octyl alcohol (e.g. 2-ethylhexanol), of nonyl alcohol, of decyl alcohol, of lauryl alcohol, of myristyl alcohol, of cetyl alcohol, of stearyl alcohol and/or of fatty and wax alcohols which occur naturally or can be obtained by hydrogenation of naturally occurring carboxylic acids. Possible alcohol components also include cycloaliphatic and/or aromatic hydroxy compounds, for example cyclohexanol and its homologues, phenol, cresol, thymol, carvacrol, benzyl alcohol and/or phenylethanol. Esters of monobasic carboxylic acids with divalent alcohols such as Texanol ester alcohols, for example 2,2,4-trimethyl-1,3-pentanediol diisobutyrate (TXIB) or 2,2,4-trimethyl-1,3-pentanediol dibenzoate; diesters of oligoalkylene glycols and alkylcarboxylic acids, for example triethylene glycol dihexanoate or tetraethylene glycol diheptanoate and analogous compounds, can also be used as plasticizers.

Additional possible plasticizers are esters of the abovementioned alcohols with phosphoric acid. Phosphoric esters of halogenated alcohols, e.g. trichloroethyl phosphate, can optionally also be used. In the latter case, a flame-retardant effect can be achieved together with the plasticizing effect. Of course, it is also possible to use mixed esters of the abovementioned alcohols and carboxylic acids.

The plasticizers can also be polymeric plasticizers, e.g. polyesters of adipic, sebacic and/or phthalic acid.

Furthermore, alkylsulfonic esters of phenol, e.g. phenyl paraffinsulfonate, and aromatic sulfonamides, e.g. ethyltoluene sulfonamide, can also be used as plasticizers. Polyethers, for example triethylene glycol dimethyl ether, can also be used as plasticizers.

The plasticizer is preferably used in an amount of from 0.1 to 15% by weight, particularly preferably from 0.5 to 10% by weight, based on the total weight of the components b) to e). The addition of plasticizer enables the mechanical properties of the rigid polyurethane foam to be improved further, in particular at low temperatures.

Further fillers, in particular reinforcing fillers, are the known, customary organic and inorganic fillers, reinforcing materials, etc. Specific examples which may be mentioned are: inorganic fillers such as siliceous minerals, for example sheet silicates such as antigorite, serpentine, hornblendes, amphiboles, chrisotile, talc; metal oxides such as kaolin, aluminum oxides, titanium oxides and iron oxides, metal salts such as chalk, barite and inorganic pigments such as cadmium sulfide, zinc sulfide and also glass and others. Preference is given to using kaolin (China clay), aluminum silicate and co-precipitates of barium sulfate and aluminum silicate and also natural and synthetic fibrous minerals such as wollastonite, metal fibers and in particular glass fibers of various lengths which may optionally be coated with a size. It is also possible to use hollow glass microspheres. Possible organic fillers are, for example: carbon, melamine, rosin, cyclopentadienyl resins and graft polymers and also cellulose fibers, polyamide, polyacrylonitrile, polyurethane and polyester fibers based on aromatic and/or aliphatic dicarboxylic esters and in particular carbon fibers.

The inorganic and organic fillers can be used either individually or as mixtures and are advantageously incorporated into the reaction mixture in amounts of from 0.5 to 30% by weight, preferably from 1 to 15% by weight, based on the weight of the components (a) to (f).

As reinforcing material, it is possible to use all materials which give the rigid polyurethane foam an even greater mechanical stability. Such reinforcing materials are, for example, glass fibers, glass fiber mats or carbon fiber mats, preferably glass fiber mats, for example Unifilio® U801 or U809 from Owens Corning Vetrotex. The proportion of reinforcing material is preferably from 5 to 15 percent by weight, based on the total weight of the rigid polyurethane foam including reinforcing material.

The invention further provides an insulating material for liquefied natural gas tanks, in particular for liquefied natural gas tanks on board ships, which comprises a rigid polyurethane foam according to the invention.

The rigid polyurethane foam of the invention is preferably produced continuously on a belt. For this purpose, the components (b) to (e) and optionally (f) are preferably mixed to form a polyol component. These are subsequently mixed with the isocyanate component (a), preferably in a low-pressure mixing apparatus, a high-pressure mixing apparatus at a reduced pressure of less than 100 bar or a high-pressure machine. As an alternative, the components (a) to (d) and optionally (e) can also each be introduced individually into the mixing apparatus. The reaction mixture obtained in this way is subsequently placed on the reinforcing material, preferably the glass fiber mats, which are preferably continuously rolled off from a plurality of drums (for example 4 to 10, preferably 6, 7 or 8) onto the belt and there form an appropriate number of layers. The amount of layers can be freely chosen and on the desired degree of foam reinforcement and on the foam height produced. The reaction mixture has to wet the fibers and quickly penetrate the layers. This penetration of the layers has to be finished before the reaction mixture starts to foam (cream time) to ensure homogeneous distribution of the mats in the final foam. The foam obtained is then preferably cured on the belt to such an extent that it can be cut into pieces without damage. This can be carried out at elevated temperatures, for example during passage through an oven. The foam pieces obtained are then preferably stored further in order to attain full mechanical strength.

The rigid polyurethane foam obtained is subsequently processed further to produce insulation panels. For this purpose, the pieces of the rigid polyurethane foam of the invention which are obtained are cut to size and preferably adhesively bonded to plywood sheets and resin-impregnated glass fiber mats. These polyurethane foam elements are then provided with further auxiliaries such as iron plates, screws and threads in order to produce the finished insulation elements which are then used directly in the production of the insulation barrier of the liquefied natural gas tank. A detailed description of the production of such insulation panels may be found, for example, on the home page of the companies Finetec and Kangrim (Korea).

Isocyanates (a) and compounds (b) having groups which are reactive toward isocyanate, physical blowing agents (c), catalysts (d), foam stabilizers (e) and optionally further additives (f) are preferably reacted in such amounts that the isocyanate index is in the range from 100 to 400, preferably 100-200, particularly preferably 110-150.

Here, the isocyanate index is, for the purposes of the invention, the stoichiometric ratio of isocyanate groups to groups which are reactive toward isocyanate multiplied by 100. Groups which are reactive toward isocyanate are in this case all isocyanate-reactive groups comprised in the reaction mixture, including chemical blowing agents but not the isocyanate group itself.

It is particularly advantageous for the reaction mixtures according to the invention to penetrate quickly into the reinforcing materials and thus promote uniform distribution of the reinforcing materials in the resulting rigid polyurethane foam. The long cream time of the reaction mixtures according to the invention combined with a short reaction time is likewise advantageous. The combination of inventive composition a) to e) gives surprisingly fast penetration times not achievable with other polyol combinations b) or with other blowing agents c).

Rigid polyurethane foams according to the invention are preferably used for insulation purposes. Rigid polyurethane foams according to the invention are particularly preferably used for the insulation of liquefied natural gas tanks, in particular on board ships (LNG carriers). They are mechanically stable, have a low thermal conductivity, display excellent foam properties, for example without holes or cracks, have good mechanical properties such as shear strengths, compressive strengths and an excellent Young's modulus, all even at low temperatures, and have a uniform distribution of the layers of reinforcing materials. The combination of the specific composition (a)/(b) and HCFO as a blowing agent leads to a reduced shrinkage, a low lamda value, a long cream time and a fast penetration time.

Further embodiments of the invention are described in the claims, the description and the examples. It goes without saying that the features mentioned above and features still to be explained below of the subject matter of the invention can be used not only in the combination indicated in each case but also in other combinations without going outside the scope of the invention.

The advantages of the invention are illustrated by the following examples.

### EXAMPLES

To produce the rigid polyurethane foams according to the invention as per examples 1 to 4 and the foams as per comparative examples C1 to C7, the polyols used were stirred with catalysts, stabilizer and blowing agent as shown in Table 1, subsequently mixed with the isocyanate and foamed to give the rigid polyurethane foam. The gel time was in each case set to 360 seconds by adapting the amount of catalyst. A constant foam density of 100 g/l was set by means of the blowing agent. The isocyanate index was in each case 130. The examples are intended to demonstrate the effect of the polyol mixture according to the invention on the properties of the foam and the foams were produced without reinforcing material for practical reasons.

Rigid polyurethane foams having the dimensions 225 mm×225 mm×225 mm were produced in a mold. After curing, the test specimens were sawn from this cube in order to determine the thermal conductivity.

The composition of the reaction mixture for producing the rigid polyurethane foams as per examples 1 to 4 and comparative examples C1 to C7 and their thermal conductivity are shown in tables 1 and 2 respectively.

TABLE 1

| Inventive Examples | 1 | 2 | 3 | 4 |
|---|---|---|---|---|
| Polyester polyol 1, OHv 315 | 50 | 26 | 50 | 50 |
| Polyester polyol 2, OHv 240 | | 21 | | |
| Succh/Gly, fn 4.3, OHv 490 | 28 | 27 | 38 | 37 |
| TDA polyol, fn 4.0, OHv 160 | | 5 | | |
| TDA polyol, fn 4.0, OHv 390 | 4 | 15 | | |
| TPG:DPG = 1:1 | 12 | | 12 | 10 |
| Glycerine | 3 | 3 | | |
| Gly-PO, OHv 805 | | | 7 | |
| Silicone stabilizer | 3 | 3 | 3 | 3 |
| Blowing agent | HFCO | HFCO | HFCO | HFCO |
| Isocyanate index | 130 | 130 | 130 | 130 |
| Lambda value 1 month(mW/mK) | 22.0 | 22.0 | 21.8 | n.d. |
| Shrinkage | Little | Little | Little | Little |
| Penetration time (s) | | | | 95 |

TABLE 2

| Comparative Examples | C1 | C2 | C3 | C4 | C5 | C6 | C7 |
|---|---|---|---|---|---|---|---|
| Polyester polyol 1, OHv 315 | | | 68 | 68 | 68 | 68 | 50 |
| Polyester polyol 2, OHv 240 | 57 | 21 | | | | | |
| Succh/Gly, fn 4.3, OHv 490 | 25 | 36 | 26 | 26 | 26 | 26 | 37 |
| TDA polyol, fn 4.0, OHv 160 | | 10 | | | | | |
| TDA polyol, fn 4.0, OHv 390 | | 30 | | | | | |
| PPG1(OHv 100):PPG2(OHv 250) = 1:1 | 12 | | | | | | 10 |
| Glycerine | 3 | | 3 | 3 | 3 | 3 | |
| Silicone stabilizer | 3 | 3 | 3 | 3 | 3 | 3 | 3 |
| Blowing agent | HFCO | HFCO | HFCO | HFCO + 0.4 H₂O | 365mfc | 245fa | 245fa |
| Isocyanate index | 130 | 130 | 130 | 130 | 130 | 130 | 130 |
| Lambda value 1 month (mW/mK) | 21.9 | 24.0 | 21.3 | 24.8 | 24.3 | 24.1 | n.t. |
| Shrinkage | Strong | Little | Strong | Little | strong | Little | Little |
| Penetration time (s) | | | | | | | 130 |

Thermal insulation is considered as good with aged lambda-values below 23 mW/m*K

Definition of Shrinkage:

Strong:>=2.5% shrinkage

Little:<=1.0% shrinkage

Measurement shrinkage: Make the foam in a 735 ml cup, after 24 hours, injecting the water into the cup until it is full. Weight the cup before and after water injection, the difference is the volume of the water. This number divided by 735 is the percentage of the shrinkage.

Definition of Penetration time: The time that the solution mixture need to penetrate the reinforcing materials (glass fibers)

Measurement penetration time:

The penetration time of the reaction mixture into the fiberglass mats was determined by placing 7 fiberglass mats (20×20 cm, Unifilio® U 801 from Saint Gobain Vetrotex) on the bottom of a mold and pouring the reaction mixture over them. The uppermost of the 7 fiberglass mats was for this purpose marked at 5 points. The penetration time reported was the time required for at least 4 of the 5 marked points to become visible again after application of the reaction mixture. After curing of this specimen, it was divided perpendicular to the fiberglass mats and the distances between the adjacent fiberglass mats were determined. The mean spacing of the fiberglass mats and also the standard deviation were calculated. The standard deviatin should be very small in the case of a uniform distribution of the mats.

Measurement lambda: Lambda values were determined in accordance with DIN EN 13165. The viscosity figures in each case relate to the viscosity at 25 ° C.

The following starting materials were used:
Polyester polyol 1: polyester polyol based on phthalic anhydride and diethylene glycol,
   functionality=2.0,
   OH number=315 mg KOH/g, viscosity=2500 mPas
Polyester polyol 2: polyesterether polyol based on phthalic anhydride and diehtylene glycol,
   functionality=2.0,
   OH number=240 mg KOH/g, viscosity=3000 mPas
Succh/Gly: polyether polyol based on sucrose and glycerine, functionality=4.3, OH number=490 mg KOH/g, viscosity=8400 mPas
TDA polyol (1): functionality=3.8, OH number=160 mg KOH/g, viscosity=650
TDA polyol (2): functionality=3.8, OH number=390 mg KOH/g, viscosity=12800
PPG1: polypropylene glycol, functionality=2.0, OH number=100 mg KOH/g, viscosity=150
PPG2: polypropylene glycol, functionality=2.0, OH number=250 mg KOH/g, viscosity=70
Isocyanate: polymeric methylenedi(phenyl diisocyanate), (PMDI), viscosity=170-250 mPas, and NCO-content between 30.5 and 32.5 w %.
Stabilizer: modified silicone-comprising foam stabilizer
Catalyst: dimethylcyclohexylamine, 10% strength by weight solution in PPG1
365 mfc: 1,1,1,3,3-pentafluorobutane, blowing agent
245 fa: 1,1,1,3,3-pentafluorobutane, blowing agent

Table 1 shows that rigid polyurethane foams according to the invention have low lambda values and little shrinkage and faster penetration times in comparison to the comparative examples (Table 2).

1. A rigid polyurethane foam obtainable by mixing
a) isocyanates,
b) compounds having groups which are reactive toward isocyanates,
c) a blowing agent,
d) catalyst,
e) one or more foam stabilisier, and optionally
f) further additives
to form a reaction mixture,
applying the reaction mixture to a reinforcing material and curing the reaction mixture,
wherein the isocyanates (a) have a viscosity of not more than 600 mPas at 25° C. and the compounds (b), having groups which are reactive toward isocyanates, comprise (b1) 45-70 wt-%, based on the total weight of (b), of an aromatic polyester polyol having a functionality of 2.5 or less and a hydroxyl number of more than 220 mg KOH/g, (b2) 20-40 wt.-%, based on the total weight of (b), of a polyether polyol having a functionality of 4 or more and a hydroxyl number of more than 400 mg KOH/g, and (b3) more than 15 wt.-%, based on the total weight of (b), of one or more low molecular-weight chain extender and/or one or more crosslinker and/or one or more o-toluene diamine initiated polyether polyol, and wherein the blowing agent comprises 1-chloro-3,3,3-trifluoropropene.

2. The rigid polyurethane foam according to claim 1, having a free rise density of 75-200 g/l.

3. The rigid polyurethane foam according to claim 1, wherein a polymeric or crude di-phenylmethane diisocyanate is employed as isocyanate component having a viscosity<600 mPas/at 25° C.

4. The rigid polyurethane foam according to claim 1, wherein at least 90 wt.-% of polyols have OH-value>50 mg KOH/g.

5. The rigid polyurethane foam according to claim 1, wherein all polyols have a viscosity below 13.000 mPas (25° C.).

6. The rigid polyurethane foam according to claim 1, wherein the component b) has a viscosity below 5000 mPas (25° C.).

7. The rigid polyurethane foam according to claim 1, wherein the molar average OH-functionality of a polyol mixture of components (b1) to (b3) is between 2.3 and 3.3 or the molar average total functionality of OH and NCO of the polyol mixture and the isocyanate component is between 2.5 and 3.0.

8. The rigid polyurethane foam according to claim 1, wherein the aromatic content of a polyol mixture of components (b1) to (b3) is based on>13 wt.-% of benzene-units in the polyols.

9. The rigid polyurethane foam according to claim 1, wherein the average density of the polyurethane foam without reinforcing material is in the range 80-150 g/l.

10. The rigid polyurethane foam according to claim 9, wherein the average density of the polyurethane foam without reinforcing material is in the range 80-120 g/l.

11. The rigid polyurethane foam according to claim 1, wherein a catalyst mixture comprising only tertiary amines is used as catalyst (d).

12. The rigid polyurethane foam according to claim 1, comprising glass fiber mats as reinforcing material in an amount of from 5 to 15 percent by weight, based on the total weight of the rigid polyurethane foam including reinforcing material.

13. The rigid polyurethane foam according to claim 1, wherein the blowing agent (c) comprises at least 90 mol % 1-chloro-3,3,3-trifluoropropene.

14. The rigid polyurethane foam according to claim 13, wherein the blowing agent (c) consists of 1-chloro-3,3,3-trifluoropropene.

15. A process for producing a rigid polyurethane foam according to claim 1, which comprises mixing
a) isocyanates,
b) compounds having groups which are reactive toward isocyanates,
c) a blowing agent,
d) a catalyst,
e) one or more foam stabilisiers, and optionally
f) further additives
to form a reaction mixture,
applying the reaction mixture to a reinforcing material and curing the reaction mixture,
wherein the isocyanates (a) have a viscosity of not more than 600 mPas at 25° C. and the compounds (b), having groups which are reactive toward isocyanates, comprise (b1) 45-70 wt-%, based on the total weight of (b), of an aromatic polyester polyol having a functionality of 2.5 or more and a hydroxyl number of more than 250 mg KOH/g (b2) 20-40 wt.-%, based on the total weight of (b), of a polyether polyol having a functionylity of more than 4 and a hydroxyl number of more than 400 mg KOH/g, and (b) more than 15 wt.-%, based on the total weight of (b), one or more low molecular weight chain extender and/or one or more crosslinker and/or one or more o-toluene diamine initiated polyether polyol, and
wherein the blowing agent comprises 1-chloro-3,3,3-trifluoropropene (“FTP”).

16. An insulating material for liquefied natural gas tanks, which comprises a rigid polyurethane foam according to claim 1.

17. The use of a rigid polyurethane foam according to claim 1 for the insulation of liquefied natural gas tanks, in particular on ships.
